(19) United States
(12) Patent Application Publication
(10) Pub. No.: US 2013/0144437 A1
(43) Pub. Date: Jun. 6, 2013

(54) MODULE AND METHOD FOR MEASURING REPULSIVE FORCE FOR WALKING ROBOT

(71) Applicants: Seok Won Lee, Hwaseong (KR); Woo Sung Yang, Hwaseong (KR)

(72) Inventors: Seok Won Lee, Hwaseong (KR); Woo Sung Yang, Hwaseong (KR)

(73) Assignee: HYUNDAI MOTOR COMPANY, Seoul (KR)

(21) Appl. No.: 13/529,147

(22) Filed: Jun. 21, 2012

(30) Foreign Application Priority Data
Dec. 5, 2011 (KR) 10-2011-0128985

(51) Int. Cl. G05B 15/00

(52) U.S. Cl. 700/258

(57) ABSTRACT

Disclosed is a module for measuring repulsive force for a walking robot. More specifically the module includes a base frame and plurality of installation units provided on the base frame and surrounded by a plurality of side surfaces configured as inclined surfaces having a predetermined angle and a top surface formed in a horizontal plane. The module also includes a 1-axis force sensor provided on each side surface and the top surface of the installation unit. A control unit calculates a sum force of the respective installation units from measurement data of the force sensor and calculates the ground reaction force (GRF) by integrating the sum force of the respective installation units.

### CROSS-REFERENCE TO RELATED APPLICATION

This application claims under 35 U.S.C. §119(a) the benefit of Korean Patent Application No. 10-2011-0128985 filed on Dec. 5, 2011, the entire contents of which are incorporated herein by reference.

### BACKGROUND

(a) Technical Field

The present invention relates to a module for measuring repulsive force of a walking robot configured as a low-price sensor module for calculating a zero moment point (ZMP) required for controlling a walking motion of a robot and measuring ground reaction force required for controlling the balance, and a method thereof.

(b) Background Art

Biped robots are understood by those skilled in the art as robots that walk on two feet while multiplied robots are those robots that walk on more then two feet. In these types of robots, measurements and feed-back of ground reaction force (GRF) are required for attitude control and balance control of the robot in real time. To this end, in a ground reaction force measuring sensor module used in an existing robot, typically use a high-price 6-axis force/torque (F/T) sensor, a force sensing resister (FSR) and a strain gauge to control the attitude and balance of the robot.

The existing F/T sensors are able to comparatively accurately measure the ground reaction force by measuring both 3-axis force and 3-axis moment. However, these existing F/T sensors are not cost effective and thus commercialization of these types of robots is effected as a result. Furthermore, existing FSR sensors are not able to measure just one vertical component.

### SUMMARY OF THE DISCLOSURE

The present invention has been made in an effort to provide a module for measuring the repulsive force of a walking robot using a low-price sensor module for calculating a zero moment point (ZMP) required for controlling walking of a robot and measuring ground reaction force required for controlling a balance, and a method thereof.

An exemplary embodiment of the present invention provides a module for measuring repulsive force for a walking robot, including: a base frame; a plurality of installation units provided on the base frame and surrounded by a plurality of side surfaces configured as inclined surfaces having a predetermined angle and a top surface formed in a horizontal plane; a 1-axis force sensor provided on each of the side surfaces and the top surface of the installation unit; and a control unit configured to calculate a sum force of the respective installation units from measurement data of the force sensor and calculate a ground reaction force (GRF) by integrating the sum force of the installation units.

Furthermore, a housing formed in surface contact with all the force sensors of the plurality of installation units may be coupled to an upper side of the base frame, and the installation unit may be configured by four pyramid-shaped side surfaces and one top surface. The 1-axis force sensor may be configured by a force sensing resistor (FSR) type 1-axis sensor, and four installation units, arranged vertically, may be provided in the base frame. The base frame may be installed on a lower end portion of a lower leg of the walking robot to provide proper measurements thereof.

The control unit may collect vertical drag of each of the installation units from the measurement data of the force sensor of the top surface of the installation unit and may calculate the zero moment point (ZMP) by integrating the collected vertical drag.

In some exemplary embodiments of the present invention provides a method for measuring repulsive force using a module for measuring repulsive force for a walking robot that includes collecting, by a control unit, the measurement data of the force sensor; calculating, by the control unit, the sum force of the respective installation units from the collected measurement data; and calculating, by the control unit, the ground reaction force (GRF) by integrating the sum force of the respective installation units.

During the integration of the sum force by the control unit, the illustrative embodiment of the present invention may also collect the measurement data related to the top surface of the installation unit from the collected measurement data; and calculate the zero moment point (ZMP) by integrating the measurement data on the top surface of the installation unit.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view of a module for measuring repulsive force of a walking robot according to an exemplary embodiment of the present invention;

FIG. 2 is a diagram showing a process of measuring ground reaction force using the module for measuring repulsive force of a walking robot shown in FIG. 1;

FIG. 3 is a diagram showing a process of measuring a zero moment point using the module for measuring repulsive force of a walking robot shown in FIG. 1; and

FIG. 4 is a flowchart of a method for measuring repulsive force of a walking robot according to another exemplary embodiment of the present invention.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Hereinafter, a module and a method for measuring repulsive force for a walking robot according to exemplary embodiments of the present invention will be described with reference to the accompanying drawings.

FIG. 1 is a perspective view of a module for measuring repulsive force of a walking robot according to an exemplary embodiment of the present invention. The module for measuring repulsive force of a walking robot according to the exemplary embodiment of the present invention includes a base frame 100, a plurality of installation units 300 provided on the base frame 100 and surrounded by a plurality of side surfaces 320 configured as inclined surfaces having a predetermined angle and a top surface 340 formed in a horizontal plane; a 1-axis force sensor 500 provided on each of the side surfaces 320 and the top surface 340 of the installation unit 300; and a control unit 600 configured to sum force of the respective installation units 300 from measurement data of the force sensor 500 and calculating ground reaction force (GRF) by integrating the sum force of the respective installation units 300.

Herein, the base frame 100 may be installed on a lower end portion of a lower leg of the walking robot to calculate ground reaction force and a zero moment point that act on to a foot of the walking robot. The robot is controlled to perform stable walking by using data deduced therethrough. In detail, the base frame 100 and the module for measuring repulsive force for a walking robot according to the exemplary embodiment of the present invention may be installed on a sole or an ankle joint of the robot.

Furthermore, the base frame 100 is configured as one panel or as four divided panels and the installation units may be installed on the respective panels or respective points.

The installation unit 300 serves as a base on which a sensor is mounted and is configured by the plurality of side surfaces 320 configured on the inclined surface having the predetermined angle and the top surfaces 340 formed in the horizontal plane. The plurality of installation units 300 are provided in the base frame 100. In addition, the 1-axis force sensor 500 is provided on each of the side surfaces 320 and the top surface 340 of the installation unit 300.

Lastly, the control unit 600 receives all the measurement data of the plurality of force sensors 500 and calculates the sum force of the respective installation units 300 from the measurement data and calculates the ground reaction force (GRF) by integrating the sum force of the respective installation units 300. That is, the force sensor 500 may be installed in the installation unit 300 as a low-price sensor capable of measuring force of only one axis measure side and vertical force.

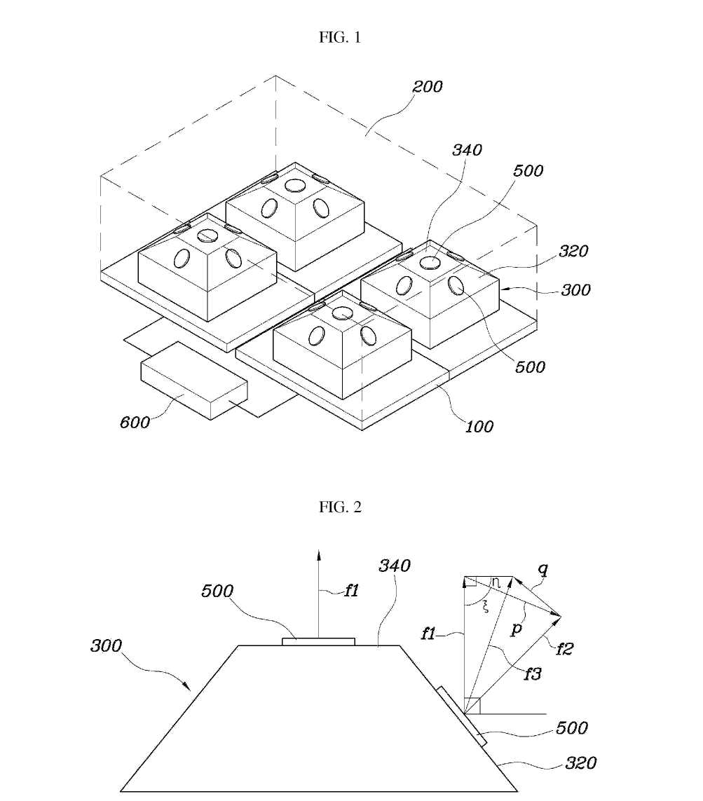

FIG. 2 is a diagram showing a process of measuring ground reaction force using the module for measuring repulsive force for a walking robot shown in FIG. 1. As shown in FIG. 2, force sensor 500 on the top surface 340 of the installation unit measures vertical force f1 and side force f2 is measured by the force sensor 500 on the side surface 320 (f2 is measured as force vertical to the side surface due to a characteristic of the 1-axis force sensor). In addition, since an inclined angle of the side surface is already known, the sum force f3 of f1 and f2 can be calculated using known trigonometry calculations. A detailed method of the sum force f3 will be able to the following equation.

$$( {f}_{1} , {f}_{2} ; sensing data from FSR ) p = \sqrt{{f}_{1}^{2} + {f}_{2}^{2} - 2 {f}_{1} {f}_{2} cos ( π / 4 )} \\ ξ = {sin}^{- 1} ( \frac{{f}_{2} \times sin ( π / 4 )}{p} ) \\ η = ( π / 2 ) - ξ \\ q = {sin}^{- 1} ( \frac{p \times sin η}{sin ( 3 π / 4 )} ) \\ \vec{GRF} = \vec{{f}_{2}} + \vec{q} \qquad [ Equation 1 ]$$

As shown in Equation 1 and FIG. 2, since f1 and f2, and the inclined angle of the side surface are known, force in a p direction can be known assumed that the inclined angle of the side surface is π/4. In addition, an angle ξ can be known through the p-direction force and an angle η and a q-direction force can be known through the angle ξ. Finally, the sum force of f2 and the p-direction force are calculated to deduce final sum force f3.

The sum force calculated in the respective installation units is calculated by using a trigonometric function and the sum force of the installation units may be calculated by one ground reaction force (GRF) through the trigonometric function again. The ground reaction force may be understood as one representative force throughout the base frame.

Meanwhile, a housing 200 formed in surface contact with all the force sensors 500 of the plurality of installation units 300 may be coupled to an upper side of the base frame 100. That is, the diagram shown in FIG. 1 is acquired through a translucent view of an internal configuration while the housing 200 covers the installation unit 300 and the base frame 100.

As shown in the figure, the plurality of installation units 300 are installed in the base frame 100, the housing 200 covers the upper side of the installation unit 300, and a groove shape corresponding to an outer surface and a layout of the installation unit 300 is formed in the housing 200, so that an inner surface of the housing 200 and the outer surface of the installation unit 300 are in surface come in contact with each other.

In more detail, the housing 200 and the force sensors 500 of the respective surfaces of the installation units 300 are in surface contact with each other, and as a result, a load applied to the housing 200 is transferred to the force sensors 500 of the respective surfaces of the installation units 300 to be sensed.

Further, the installation unit 300 may be configured by four pyramid-shaped side surfaces 320 and one top surface 340. In addition, the 1-axis force sensor 500 may be embodied as a force sensing resistor (FSR) type 1-axis sensor. The FSR sensor may use a resistor type configuration and can sense only a load on one axis. Advantageously, however, these sensors are low-cost, and therefore, the FSR sensor can be optimally used in a low-cost robot when the FSR sensor is configured utilizing the illustrative embodiment of the present invention.

Meanwhile, as shown in FIG. 1, four installation units 300 arranged vertically may be provided on the base frame 100 to acquire a final ground reaction force. Also, the control unit 600 collects vertical drag of each of the installation units 300 from the measurement data of the force sensor 500 of the top surface 340 of the installation unit and may calculate the zero moment point (ZMP) by integrating the collected vertical drag.

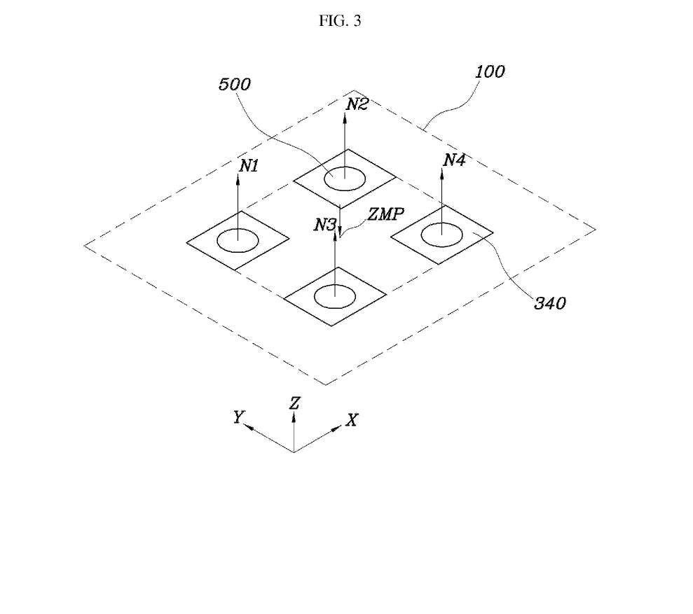

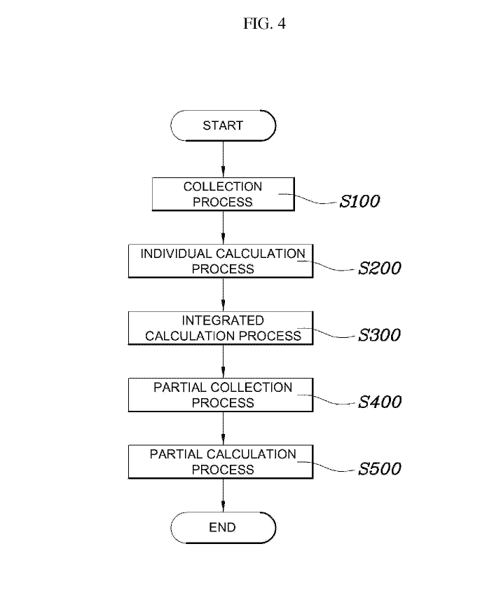

FIG. 3 is a diagram showing a process of measuring a zero moment point using the module for measuring repulsive force of a walking robot shown in FIG. 1. The force sensors 500 of the top surface 340 of the installation unit 300 sense the vertical load and select a predetermined point as an original point and when a point where the sum of moments is 0 with respect to four respective vertical loads is calculated from the original point, the corresponding point may be calculated as the zero moment point (ZMP). Therefore, according to the module for measuring repulsive force of a walking robot, the ground reaction force and the zero moment point can be acquired and the numerical value may be effectively used to control the stability of robot walking.

FIG. 4 is a flowchart of a method for measuring repulsive force for a walking robot according to another exemplary embodiment of the present invention. The method executed by the control unit 600 for measuring repulsive force using the module for measuring repulsive force for a walking robot includes: a collection process (S100) of collecting the measurement data of the force sensor; an individual calculation process (S200) of calculating the sum force of the respective installation units from the collected measurement data; and an integrated calculation process (S300) of calculating the ground reaction force (GRF) by integrating the sum force of the respective installation units.

In addition, the integrated calculation process (S300) may include a partial collection process (S400) of collecting the measurement data on the top surface of the installation unit from the collected measurement data; and a partial calculation process (S500) of calculating the zero moment point (ZMP) by integrating the measurement data on the top surface of the installation unit to calculate even the zero moment point.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Thus, advantageously, a module and a method for measuring repulsive force of a walking robot can effectively acquire a three dimensional ground reaction force generated when a biped walking robot while performing walking by using a low-cost sensor module and calculating a zero moment point using the same. Further, walking states (two-feet supported, one-foot supported, and the like) of a biped robot can be determined through a modularized sensor. The module and the method can be utilized in attitude control and balance control in a walking robot by using the ground reaction force and the zero moment point.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. A module for measuring repulsive force of a walking robot, comprising:
a base frame;
a plurality of installation units provided on the base frame and surrounded by a plurality of side surfaces configured as inclined surfaces having a predetermined angle and a top surface formed in a horizontal plane;
a plurality of 1-axis force sensors provided on each of the plurality of side surfaces and the top surface of each of the installation units; and
a control unit configured to calculate a sum force of the plurality of installation units from measurement data from the force sensors on each installation unit and calculate a ground reaction force (GRF) by integrating the sum force of the plurality of installation units.

2. The module for measuring repulsive force for a walking robot of claim 1, wherein a housing formed in surface contact with all the force sensors of the plurality of installation units is coupled to an upper side of the base frame.

3. The module for measuring repulsive force of a walking robot of claim 1, wherein each installation unit is configured as pyramid-shaped side surfaces and one top surface.

4. The module for measuring repulsive force of a walking robot of claim 1, wherein each of the 1-axis force sensors are configured as a force sensing resistor (FSR) type 1-axis sensor.

5. The module for measuring repulsive force of a walking robot of claim 1, wherein four installation units arranged vertically are provided on the base frame.

6. The module for measuring repulsive force of a walking robot of claim 1, wherein the base frame is installed on a lower end portion of a lower leg of the walking robot.

7. The module for measuring repulsive force of a walking robot of claim 1, wherein the control unit is configured to collect a vertical drag of each of the installation units from measurement data from the force sensor on the top surface of each of the installation units and calculate the zero moment point (ZMP) by integrating the collected vertical drag.

8. A method for measuring repulsive force of a walking robot using a module for measuring repulsive force for a walking robot, comprising:
collecting, by a control unit, measurement data from a plurality of force sensors;
calculating, by the control unit, a sum force of the plurality of installation units from the collected measurement data; and
calculating, by the control unit, a ground reaction force (GRF) by integrating the sum force of the plurality of installation units.

9. The method for measuring repulsive force of a walking robot of claim 8, further comprising:
collecting, by the control unit during integration of the sum force, the measurement data on the top surface of the installation unit from the collected measurement data; and
calculating, by the control unit, a zero moment point (ZMP) by integrating the measurement data on the top surface of the installation unit.

10. A non-transitory computer readable medium containing program instructions executed by a processor or controller, the computer readable medium comprising:
program instructions that collect measurement data from a plurality of force sensors;
program instructions that calculate a sum force of the plurality of installation units from the collected measurement data; and
program instructions that calculate a ground reaction force (GRF) by integrating the sum force of the plurality of installation units.

11. The non-transitory computer readable medium of claim 10, further comprising:
program instructions that collect during integration of the sum force, the measurement data on the top surface of the installation unit from the collected measurement data; and
program instructions that calculate a zero moment point (ZMP) by integrating the measurement data on the top surface of the installation unit.
